(19) United States
(12) Patent Application Publication
(10) Pub. No.: US 2016/0131967 A1
(43) Pub. Date: May 12, 2016

(54) ILLUMINATION OPTICAL SYSTEM AND PROJECTOR

(71) Applicant: NEC DISPLAY SOLUTIONS, LTD., Tokyo (JP)

(72) Inventor: Hiroyuki SAITOU, Tokyo (JP)

(21) Appl. No.: 14/889,175

(22) PCT Filed: Jun. 4, 2013
(86) PCT No.: PCT/JP2013/065477

§ 371 Date: Nov. 5, 2015

(51) Int. Cl. G03B 21/20; F21V 14/06; G02B 27/14; F21V 5/00

(52) U.S. Cl. CPC G03B 21/2013; F21V 5/008; F21V 14/06; G03B 21/2033; G03B 21/208; G02B 27/141; G03B 21/204; F21Y 2101/025

(57) ABSTRACT

Provided is an illumination optical system that can approximate the radiation angle characteristics of synthesized fluorescent light and laser light to each other. Illumination optical system includes laser light source, fluorescent light source, synthetic optical system configured to synthesize laser light emitted from the laser light source and fluorescent light emitted from the fluorescent light source, first lens, second lens, and third lens. The first lens is provided between the laser light source and the synthetic optical system. The second lens is provided immediately in front of the synthetic optical system on the optical path of the laser light that passed through the first lens. The third lens is provided immediately in front of the synthetic optical system on the optical path of the fluorescent light emitted from the fluorescent light source. The sum of the focal distance of the first lens and the focal distance of the second lens is set so that the maximum value of an angle formed between the laser light that passed through the second lens and the optical axis of the second lens can substantially match the maximum value of an angle formed between the fluorescent light that passed through the third lens and the optical axis of the third lens.

### TECHNICAL FIELD

The present invention relates to an illumination optical system that includes a synthetic optical system configured to synthesize laser light emitted from a laser light source with fluorescent light emitted from a phosphor, and a projector that includes the illumination optical system.

### BACKGROUND ART

Due to the restrictions that result from etendue in an illumination optical system for a liquid crystal projector, a DMD (Digital Micromirror Device) projector or the like, increasing the amount of light without increasing the light-emitting area of the light source is a desirable goal. Therefore, as described in JP2012-141495A (hereinafter, referred to as Patent Document 1) and JP2011-013313A (hereinafter, referred to as Patent Document 2), an illumination optical system has been developed that uses a phosphor irradiated with excitation light to emit fluorescent light. By condensing the excitation light such as laser light on a small area on the phosphor, the amount of light can be increased without increasing the light-emitting area.

In Patent Document 1, a projector that uses a phosphor irradiated with excitation light to emit yellow fluorescent light, and a laser light source for emitting blue laser light are described. The yellow fluorescent light emitted from the phosphor includes a red light component and a green light component. Thus, this projector can project a full-color image on a screen.

In Patent Document 2, there is described an illumination optical system that includes a wheel having the layer of a first phosphor, the layer of a second phosphor, and a transmission part, and a laser light source for emitting blue laser light. When the first phosphor is irradiated with the blue laser light from the laser light source, the first phosphor emits red fluorescent light. When the second phosphor is irradiated with the blue laser light, the second phosphor emits green fluorescent light. When the transmission part is irradiated with the blue laser light, the blue laser light is transmitted through the wheel. The blue laser light that is transmitted through the transmission part is synthesized with the red fluorescent light and the green fluorescent light that is emitted from the phosphors by a dichroic mirror.

### CITATION LIST

Patent Document 1: JP2012-141495A
Patent Document 2: JP2011-013313A

### SUMMARY OF INVENTION

### Problem to be Solved by the Invention

Generally, the radiation angle characteristics of the fluorescent light emitted from the phosphor are different from those emitted from the laser light source. This difference in radiation angle characteristics causes a difference between the distribution of the laser light transmittable through the projection lens of the projector and the distribution of the fluorescent light transmittable through the projection lens. As a result, when synthetic light obtained by synthesizing the fluorescent light emitted from the phosphor and the laser light emitted from the laser light source is utilized, color irregularity may occur in the image projected on the screen.

It is therefore desirable to provide an illumination optical system that can solve the above-mentioned problem.

### Means to Solve the Problem

An illumination optical system according to the exemplary embodiment of the present invention includes a laser light source, a fluorescent light source, a synthetic optical system configured to synthesize laser light emitted from the laser light source and fluorescent light emitted from the fluorescent light source, a first lens, a second lens, and a third lens. The first lens is provided between the laser light source and the synthetic optical system. The second lens is provided immediately in front of the synthetic optical system on the optical path of the laser light that passed through the first lens. The third lens is provided immediately in front of the synthetic optical system on the optical path of the fluorescent light emitted from the fluorescent light source. The sum of the focal distance of the first lens and the focal distance of the second lens is set so that the maximum value of an angle formed between the laser light that passed through the second lens and the optical axis of the second lens can substantially match the maximum value of an angle formed between the fluorescent light that passed through the third lens and the optical axis of the third lens.

The above-mentioned configuration enables the radiation angle characteristics of synthesized laser light and fluorescent light to be approximated to each other.

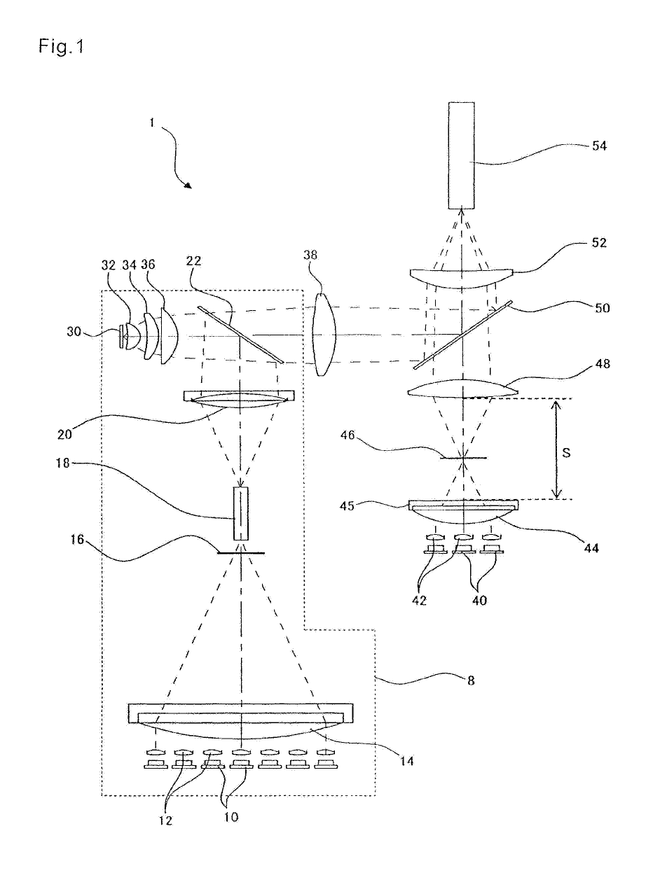

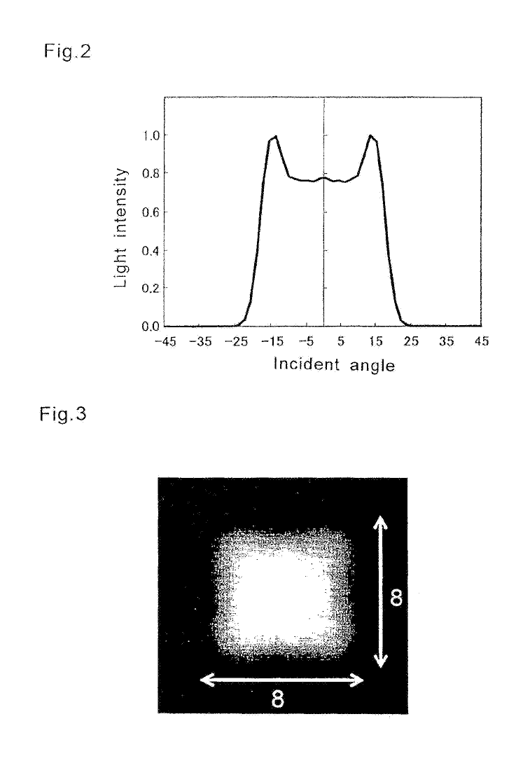

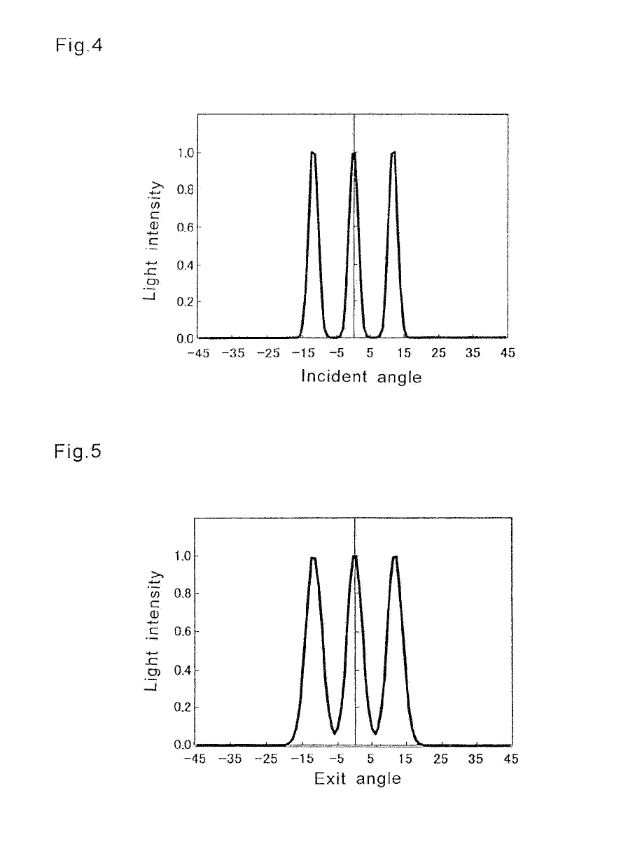

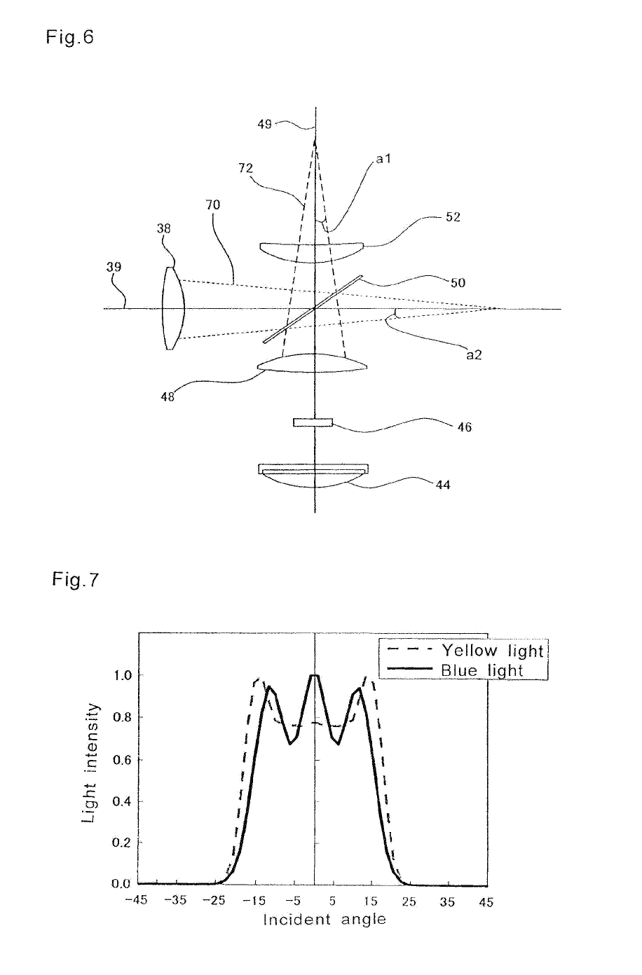

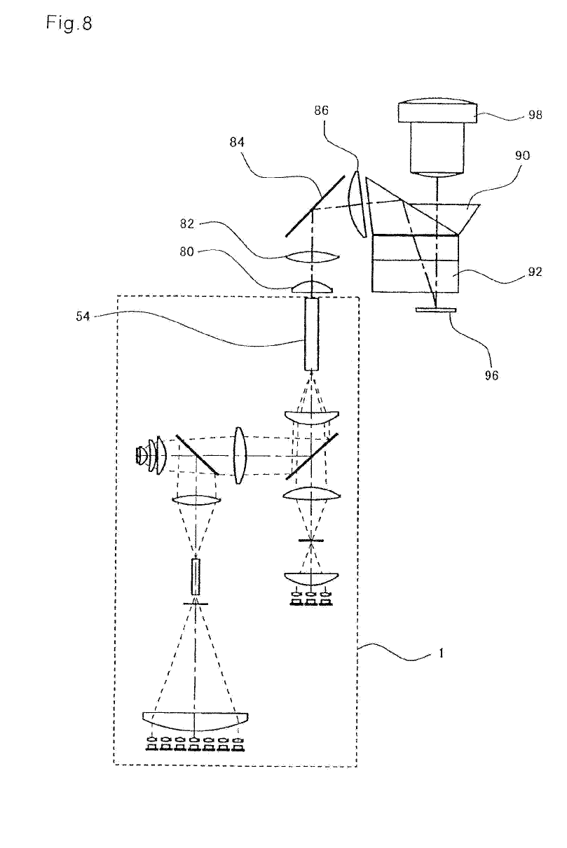

### BRIEF DESCRIPTION OF DRAWINGS

[FIG. 1] A diagram illustrating the schematic configuration of an illumination optical system according to one exemplary embodiment of the present invention.

[FIG. 2] A graph illustrating the incident angle dependence of the light intensity (incident angle—light intensity distribution) of yellow light on the incidence plane of light tunnel 54.

[FIG. 3] A diagram illustrating the illuminance distribution of blue laser light on the incidence plane of diffusion plate 46.

[FIG. 4] A graph illustrating the incident angle dependence of the light intensity (incident angle—light intensity distribution) of the blue laser light on the incidence plane of diffusion plate 46.

[FIG. 5] A graph illustrating the exit angle dependence of the light intensity (exit angle—light intensity distribution) of the blue laser light immediately after its exit from diffusion plate 46.

[FIG. 6] A schematic diagram illustrating the incident angles of laser light and fluorescent light on an integrator in the illumination optical system illustrated in FIG. 1.

[FIG. 7] A graph illustrating the incident angle dependence of the light intensity (incident angle—light intensity distribution) of each of the blue laser light and yellow fluorescent light on the incidence plane of light tunnel 54.

[FIG. 8] A diagram illustrating the schematic configuration of a projector that includes the illumination optical system illustrated in FIG. 1.

### DESCRIPTION OF EXEMPLARY EMBODIMENTS

Hereinafter, the exemplary embodiments of the present invention will be described with reference to the drawings. FIG. 1 illustrates the configuration of an illumination optical system according to one exemplary embodiment of the present invention.

Illumination optical system 1 includes fluorescent light source 8, first laser light source 40 for emitting laser light, and synthetic optical system 50 configured to synthesize the laser light emitted from first laser light source 40 and fluorescent light emitted from fluorescent light source 8. Fluorescent light source 8 includes phosphor 30 irradiated with excitation light to emit fluorescent light, and second laser light source 10 for emitting the excitation light applied to phosphor 30. First laser light source 40 may be a source for emitting blue laser light having a blue wavelength. Phosphor 30 may be a phosphor for emitting yellow fluorescent light having a wavelength range from a green wavelength to a red wavelength. Synthesizing this yellow fluorescent light and the blue laser light at synthetic optical system 50 enables white light to be obtained.

Second laser light source 10 may be a plurality of laser diodes arranged on a plane. Each laser diode emits excitation light to excite the phosphor. The laser diode is preferably a blue laser diode.

The blue laser light emitted from second light source 10 is converted into parallel light through lens 12. The light converted into parallel light (collimated light) through lens 12 is condensed on the incident side opening of light tunnel 18 by condenser lens 14. Diffusion plate 16 is provided for diffusing the laser light between lens 14 and light tunnel 18. Light tunnel 18 is a hollow optical element, and the left, right, top and bottom inner surfaces thereof are reflection mirrors. The blue laser light that is made incident on light tunnel 18 is reflected on the inner surface of the light tunnel for a plurality of times. Accordingly, the illuminance distribution of the light on the exit part of light tunnel 18 is made uniform. In place of light tunnel 18, a glass rod (rod integrator) may be used.

The blue laser light output from light tunnel 18 is transmitted through lens 21 to enter dichroic mirror 22. Dichroic mirror 22 reflects light having a blue wavelength while transmitting light having a wavelength longer than a green wavelength. Accordingly, the blue laser light is reflected on dichroic mirror 22. The blue laser light reflected on dichroic mirror 22 is transmitted through lenses 36, 34, and 32 to illuminate phosphor 30. Phosphor 30 is excited by the blue laser light to radiate yellow fluorescent light.

The yellow light radiated from phosphor 30 is transmitted through lenses 32, 34, and 36, and dichroic mirror 22 in this order. The yellow light transmitted through dichroic mirror 22 is transmitted through third lens 38 provided immediately in front of synthetic optical system 50 on the optical path of the fluorescent light emitted from the phosphor. The yellow light transmitted through third lens 38 enters synthetic optical system 50. Third lens 38 preferably converts the fluorescent light emitted from phosphor 30 into parallel light or condensed light.

Synthetic optical system 50 may have any configuration as long as it can synthesize the laser light emitted from first laser light source 10 and the fluorescent light emitted from phosphor 30. According to the exemplary embodiment, the synthetic optical system is a dichroic mirror that reflects the laser light emitted from laser light source 40 or the fluorescent light emitted from the phosphor while transmitting the unreflected laser or fluorescent light. More specifically, this dichroic mirror transmits the light having the blue wavelength while reflecting the light having the wavelength longer than the green wavelength. Accordingly, dichroic mirror 50 reflects the yellow light emitted from phosphor 30 while transmitting the blue laser light emitted from first laser light source 10.

First laser light source 40 may include a plurality of blue laser diodes arranged on a plane. The laser diode radiates laser light from a luminous point having a very small area. The blue laser light radiated from first light source 40 is converted into parallel light (collimated light) through lens 42, and then condensed by first lens 44 provided between first laser light source 40 and synthetic optical system 50.

Illumination optical system 1 preferably includes diffusion plate 46 for diffusing the laser light emitted from first laser light source 40. Diffusion plate 46 is provided between first lens 44 and second lens 48.

The distance between second lens 48 and first lens 44 is preferably a distance that is longer than the focal distance of first lens 44. In this case, the condensed part of the laser light condensed through first lens 44 is disposed between first lens 44 and second lens 48. Diffusion plate 46 is preferably provided in the vicinity of the condensed part of the laser light that passed through first lens 44, in other words, in the vicinity of the focal point of first lens 44.

The blue laser light diffused by diffusion plate 46 is transmitted through second lens 48 that is provided immediately in front of synthetic optical system 50 on the optical path of the laser light transmitted through first lens 44. The blue laser light that is transmitted through second lens 48 enters dichroic mirror 50 that is the synthetic optical system. The blue laser light is transmitted through dichroic mirror 50. The blue laser light that is transmitted through dichroic mirror 50 is synthesized with the yellow fluorescent light reflected on dichroic mirror 50.

When the synthetic optical system is the dichroic mirror, reduction of reflectance/transmittance caused by the incident angle characteristics of the dichroic mirror must be prevented. The angle of the incident light on the dichroic mirror is shifted, in general, from 45 degrees, and transmission characteristics or reflection characteristics thereof are reduced.

Thus, according to the exemplary embodiment, second lens 48 and third lens 38 are designed so that the incident angles of the lights output through second lens 48 and third lens 38 on dichroic mirror 50 may be 45°±10°.

The synthetic light synthesized by dichroic mirror 50, in other words, the synthetic light of the blue laser light and the yellow fluorescent light, is transmitted through condenser lens 52, and enters integrator 54 which causes the illuminance distribution of the synthetic light to become uniform. Condenser lens 52 condenses the synthetic light on integrator 54. In the exemplary embodiment, light tunnel 54 is used as the integrator.

FIG. 2 illustrates the incident angle dependence of the light intensity (incident angle—light intensity distribution) of the yellow fluorescent light on the incidence plane of light tunnel 54. In a graph illustrated in FIG. 2, the light intensity is normalized in order that the peak value of the light intensity may be “1”. As illustrated in the graph, the yellow light made incident on light tunnel 54 has an incident angle within the range of −24° to +24°. In other words, the incident angle of the yellow light on the incidence plane of light tunnel 54 is distributed within the angle range of about 48°.

The laser light emitted from first laser light source 40 is converted into parallel light through collimator lens 42. This parallel light is a ray having a very small light spread and high linearity. FIG. 3 illustrates the illuminance distribution of the blue laser light on the incidence plane of diffusion plate 46. In FIG. 3, a bright white region indicates a region in which the illuminance of the laser light is strong. FIG. 4 illustrates the incident angle dependence of the light intensity (incident angle—light intensity distribution) of the blue laser light on the incidence plane of diffusion plate 46. In a graph illustrated in FIG. 4, the light intensity is normalized in order that the peak value of the light intensity may be “1”. In the exemplary embodiment, the size (diameter) of the blue laser light on the incidence plane of diffusion plate 46 is about 8 mm×8 mm, and the incident angle of the blue laser light is distributed within the angle range of about −15° to 15°.

In the graph illustrated in FIG. 4, there are light intensity peaks at three locations. These peaks depend on the position of first laser light source 40, in other words, the distances from optical axis 49 of first and second lenses 44 and 48. The foot spread of each peak has a very small angle of about 3°. When the graphs illustrated in FIGS. 2 and 4 are compared with each other, it can be understood that the radiation angle characteristics of the laser light emitted from first laser light source 40 differ greatly from those of the yellow fluorescent light.

FIG. 5 illustrates the exit angle dependence of the light intensity (exit angle—light intensity distribution) of the blue laser light immediately after it has exited from diffusion plate 46. In the graph illustrated in FIG. 5, the light intensity is normalized so that the peak value of the light intensity may be “1”. The exit angle of the laser light diffused by diffusion plate 46 is distributed within a range of about 36°. The position of the intensity peak of the laser light diffused by diffusion plate 46 is almost similar to that of the laser light in front of the incidence on diffusion plate 46. However, the diffusion by diffusion plate 46 causes the spread of each peak to increase by about 6°.

It is preferable that condition “S>f12” be satisfied, in which f12 is the focal distance of first lens 44, f13 is the focal distance of second lens 48, and S is a distance between first lens 44 and second lens 48. This condition enables the condensing point of the blue laser light to be set between first lens 44 and second lens 48. The image of this condensing point is formed on the incident position of light tunnel 54 by second lens 48 and condenser lens 52.

It is more preferable that the condition “f12+f13≦S” be satisfied. When the condition of “f12+f13=S” is satisfied, the laser light output through second lens 48 is roughly parallel light. When the condition “f12+f13<S” is satisfied, the laser light output through second lens 48 is condensed light. This way, according to the value of the sum of focal distance f12 of first lens 44 and focal distance f13 of second lens 48, the exit angle of the laser light that passed through second lens 48 can be adjusted. Converting the laser light output through second lens 48 into the parallel light or the condensed light enables preventing an increase in the size of the lens system that is disposed behind the second lens.

Herein, according to the present invention, the sum “f12+f13” of the focal distance of first lens 44 and the focal distance of second lens 48 is set so that maximum value al of an angle between laser light 72 that passed through second lens 48 and optical axis 49 of the second lens can substantially match maximum value a2 of an angle between fluorescent light 70 that passed through third lens 38 and optical axis 39 of the third lens (see FIG. 6). The optical axis of the lens means a straight line orthogonal to a tangent plane that passes through the spherical apex of the lens, a straight line that passes through the center of the lens, in other words, the spherical apex of the lens. In FIG. 6, to illustrate exit angles a1 and a2 of light that passed through second lens 48 and third lens 38, light fluxes thereof when dichroic mirror 50 or condenser lens 52 is absent are indicated by dotted lines.

Setting the sum of the focal distance of first lens 44 and the focal distance of second lens 48 as described above enables the radiation angle characteristics of the blue laser light and the fluorescent light that are synthesized at synthetic optical system 50 to be approximated to each other. FIG. 7 illustrates the incident angle dependence of the light intensity (incident angle—intensity distribution) on the incident position of light tunnel 54. In the graph illustrated in FIG. 7, the light intensity of the yellow light emitted from phosphor 30 is indicated by a dotted line, while the light intensity of the laser light emitted from first laser light source 40 is indicated by a solid line. The fluorescent light from phosphor 30 has an angle range of about 40° at an intensity that is 10% of the peak intensity. The laser light from first laser light source 40 has an angle range of about 38° at an intensity that is 10% of the peak intensity.

Appropriately setting the focal distances of first lens 44 and second lens 48 as described above enables the angle ranges at an intensity that is 10% of the light peak intensity to approximately match each other. As a result, the radiation angle characteristics of the fluorescent light and the laser light that are synthesized at synthetic optical system 50 can be substantially approximated to each other, and the color irregularity of the synthetic light can be prevented. From the standpoint of preventing any occurrence of color irregularity in the synthetic light, it is desirable that at an intensity that is 10% of the peak intensity, the difference between the angle range of the laser light and the angle range of the fluorescent light be within 10%. In the exemplary embodiment, as illustrated in FIG. 7, at an intensity that is 10% of the peak intensity, the difference between the angle range of the laser light and the angle range of the fluorescent light is about 5%.

In the exemplary embodiment, first lens 44, second lens 48, and condenser lens 52 are arranged so that an image forming relationship can be set between the condensed part in the vicinity of diffusion plate 46 and the incident position of light tunnel 54 and the incident angle distribution of the laser light and the incident angle distribution of the fluorescent light can approximately match each other at the incident position of light tunnel 54. For the image forming relationship between the condensed part in the vicinity of diffusion plate 46 and the incident position of light tunnel 54, the illumination size illustrated in FIG. 3 is preferably set to be smaller than the size of the incident opening of light tunnel 54 at the incident position of light tunnel 54. Here, since condenser lens 52 has a function of condensing the fluorescent light from phosphor 30, condenser lens 52 is not a lens that acts exclusively on the laser light from first light source 40. Therefore, condenser lens 52 does not have any function of balancing the incident angle distributions of the fluorescent light and the laser light.

Thus, by setting the positional relationship and the focal distances of first lens 44 and second lens 48, the incident angle distribution of the laser light to light tunnel 54 is adjusted to approximately match the incident angle distribution of the fluorescent light to light tunnel 54. In this case, by utilizing the diffusion characteristics of diffusion plate 46 provided between first lens 44 and second lens 48, the degree of matching in incident angle distribution between both the lenses can be further increased.

The position of at least one of first lens 44 and second lens 48 is preferably adjustable. In the exemplary embodiment, lens holder 45 holding first lens 44 is movable so as to vary the position of first lens 44. Accordingly, for example, even when the condensing position of the laser light shifts due to the dimension tolerance or the holding structure of the optical component of illumination optical system 1, the condensing position can be easily fine-adjusted.

As illustrated in FIG. 1, the laser light converted into the parallel light (collimated light) through lens 42 is condensed on the incident side opening of light tunnel 54. However, when the condensing position shifts from the incident side opening of light tunnel 54, light utilization efficiency may decrease. In order to prevent this decrease, holding unit 45 that holds first lens 44 preferably has a moving mechanism. Through this moving mechanism, by adjusting the position of first lens 44, the condensing position of the laser light can be adjusted. By adjusting the moving mechanism to maximize the brightness of the light that passed through light tunnel 54, shifting of the condensing position of the light can be corrected.

Next, a projector that includes the above-mentioned illumination optical system will be described. FIG. 8 illustrates one example of the configuration of the projector. The projector includes illumination optical system 1 illustrated in FIG. 1. The light output through light tunnel 54 of illumination optical system 1 is synthesized yellow and blue light, in other words, white light. This white light is transmitted through lenses 80 and 82, reflected on mirror 84, and further transmitted through lens 86. The white light transmitted through lens 86 enters TIR prism 90. The light that has entered TIR prism 90 is totally reflected in the prism, and enters color prism 92.

Color prism 92 divides the white light into green light, red light, and blue light. In FIG. 8, for convenience, only the optical path of the green light divided by color prism 92 is illustrated. The green light divided by color prism 92 enters green light digital mirror device (DMD) 96. Similarly, the red light enters a red light DMD (not illustrated), and the blue light enters a blue light DMD (not illustrated).

DMD 96 is a semiconductor projection device that includes multiple micromirrors arranged in a matrix. Each micromirror corresponds to the pixel of a projected image. The angle of each micromirror is adjustable. Light that entered into the micromirror having a certain angle (ON state) is reflected toward projection lens 98, and magnified to be projected on a screen.

Specifically, the green light, the red light, and the blue light that entered into the micromirror of the ON state enter color prism 92, and are synthesized at color prism 92. The synthetic light synthesized at color prism 92 passes through TIR prism 90 and projection lens 98 to be projected on the screen.

Light that entered into the micromirror having another angle (OFF state) is reflected in a direction different from projection lens 98, and not projected on the screen. By changing the time ratio of the ON state and the OFF state at each micromirror, the gradation of each pixel of an image projected on the screen can be adjusted.

Projection lens 98 projects the image light of a plurality of colors formed by the DMD on the screen. In illumination optical system 1 described above, the angle—intensity distributions of the laser light and the fluorescent light synthesized at synthetic optical system 50 approximately match each other. Accordingly, even after reflection on DMD 96, the angle distributions of the red light, the green light, and the blue light roughly match one another.

Here, regarding the light reflected in the vicinity of the center of the DMD of the ON state, only light having an angle range determined by the F-number of projection lens 98 can be transmitted through projection lens 98. On the other hand, regarding the light reflected in the vicinity of the periphery of the DMD of the ON state, only light having an angle range determined by the F-number of projection lens 98 and the amount of light on the periphery can be transmitted through projection lens 98. Therefore, when there is a difference in incident angle distribution among the red light, the green light, and the blue light, color irregularity may occur in the image or in a video projected on the screen. Since the incident angle distribution of the red light, green light, and blue light roughly match each another, color irregularity, as indicated above can be prevented by using illumination optical system 1, described above, according to the present invention.

The preferred exemplary embodiments of the present invention have been described in detail. However, the present invention is not limited to the above-mentioned exemplary embodiments. It should be understood that various changes and modifications can be made without departing from the spirit and the scope of the present invention.

For example, the above-mentioned exemplary embodiments have been directed to the illumination optical system that synthesizes blue laser light and yellow fluorescent light. Not limited to this, however, the illumination optical system may be a system that synthesizes laser light having any wavelength and fluorescent light having any wavelength. In addition, the configuration of fluorescent light source 8 is not limited to that illustrated in FIG. 1 as long as it can emit fluorescent light.

### REFERENCE NUMERALS

1 Illumination optical system
8 Fluorescent light source
10 Second light source
22 Dichroic mirror
30 Phosphor
38 Third lens
40 Laser light source
42 Collimator lens
44 First lens
46 Diffusion plate
48 Second lens
50 Synthetic optical system (dichroic mirror)
52 Condenser lens
54 Integrator (light tunnel)

1.
An illumination optical system comprising:
a laser light source for emitting laser light;
a fluorescent light source for emitting fluorescent light;
a synthetic optical system for synthesizing the laser light emitted from the laser light source and the fluorescent light emitted from the fluorescent light source;
a first lens provided on a light path between the laser light source and the synthetic optical system;
a second lens provided immediately in front of the synthetic optical system on an optical path of the laser light that passed through the first lens; and
a third lens provided immediately in front of the synthetic optical system on an optical path of the fluorescent light emitted from the fluorescent light source,
wherein a sum of a focal distance of the first lens and a focal distance of the second lens is set so that a maximum value of an angle between the laser light that passed through the second lens and an optical axis of the second lens can substantially match a maximum value of an angle between the fluorescent light that passed through the third lens and an optical axis of the third lens.

2.
The illumination optical system according to claim 1, wherein:
the first lens condenses the laser light emitted from the first laser light source;
distance between the second lens and the first lens is a distance that is longer than the focal distance of the first lens; and
a diffusion plate is provided in the vicinity of a focal point of the first lens.

3.
The illumination optical system according to claim 1, wherein:
the second lens converts the laser light into parallel light or condensed light; and
the third lens converts the fluorescent light into parallel light or condensed light.

4.
The illumination optical system according to claim 1, wherein the laser light source includes an array of laser diodes.

5.
The illumination optical system according to claim 1, wherein a position of at least one of the first lens and the second lens is adjustable.

6.
The illumination optical system according to claim 1, further comprising:
an integrator configured to cause an illuminance distribution of synthetic light of the laser light and the fluorescent light to be uniform; and
a condenser lens for condensing the synthetic light on an incident position of the integrator.

7.
The illumination optical system according to of claim 1, wherein:
the fluorescent light source emits yellow fluorescent light having a wavelength range from a green wavelength to a red wavelength; and
the laser light source emits laser light having a blue wavelength.

8.
The illumination optical system according to claim 1, wherein the synthetic optical system comprises a dichroic mirror for reflecting the laser light or the fluorescent light while transmitting the unreflected laser or fluorescent light.

9.
The illumination optical system according to claim 1, wherein the fluorescent light source includes a phosphor irradiated with excitation light to emit the fluorescent light and another laser light source for emitting the excitation light applied to the phosphor.

10.
A projector comprising the illumination optical system according to claims 1.
